(19) United States
(12) Patent Application Publication
(10) Pub. No.: US 2025/0349034 A1
(43) Pub. Date: Nov. 13, 2025

(54) LOSSY FRAME BUFFER COMPRESSION

(71) Applicant: NVIDIA Corporation, Santa Clara, CA (US)

(72) Inventor: Tomas Akenine-Moller, Lund (SE)

(21) Appl. No.: 18/961,291

(22) Filed: Nov. 26, 2024

Related U.S. Application Data
(60) Provisional application No. 63/645,677, filed on May 10, 2024.

(51) Int. Cl. G06T 9/00; G06T 1/20; G06T 3/4007

(52) U.S. Cl. CPC G06T 9/00; G06T 1/20; G06T 3/4007

(57) ABSTRACT

Frame buffer compression schemes used for image compression are oftentimes lossless so that the image can be decompressed as close as possible back to its original state. However, lossless compression schemes require that any image data that cannot be successfully compressed (i.e. without losing significant data) be kept in a non-compressed state for transmission and storage. As a result, lossless compression can reduce bandwidth requirements but not memory requirements. The more recently introduced lossy frame buffer compression schemes do allow for some data loss and therefore can save both bandwidth and memory, however, lossy frame buffer compression schemes are limited particularly in the amount by which image data can practically be reduced. The present disclosure provides lossy frame buffer compression which involves an additional compression step, thereby allowing image data to be compressed to a lower rate. This lossy frame buffer compression can reduce both bandwidth and memory usage.

### RELATED APPLICATION(S)

This application claims the benefit of U.S. Provisional Application No. 63/645,677 (Attorney Docket No. NVIDP1403+/24-SV-0567US01) titled “A LOSSY FRAME BUFFER COMPRESSION ALGORITHM,” filed May 10, 2024, the entire contents of which is incorporated herein by reference.

### TECHNICAL FIELD

The present disclosure relates image compression schemes.

### BACKGROUND

Image processing schemes are typically used to render images for presentation on a display device. These schemes often involve some image (e.g. texture) compression to reduce a size of the image data which in turn reduces the bandwidth associated with transmission of the image data, the memory required to store the image data, and the processing power required to process the image data.

Image compression can be implemented as frame buffer compression where each image (e.g. frame of a video) stored in a buffer is compressed. This compression may occur prior to transmission, storage, and processing of the image. This compression may be performed by a graphics processing unit (GPU).

Traditionally, frame buffer compression schemes have been lossless (i.e. without losing any information), where rectangular blocks (i.e. “tiles”) of pixels are compressed at a time. Each block can typically be compressed down to one of a few selected rates, such as 50%, 25%, or 12.5%. If the compression algorithm does not succeed in compressing a block, the lossless schemes always have a fallback option to send the image data over the bus in a non-compressed format (and thus also storing the data in a non-compressed format). As such, the lossless frame buffer compression schemes do not reduce storage, but instead they only reduce bandwidth usage.

More recently, lossy frame buffer compression schemes have been introduced (which allow for some information loss). These schemes can provide both bandwidth and memory savings. However, to date the implementations of these lossy frame buffer compression schemes have been limited. For example, current implementations of lossy frame buffer compression are particularly limited in the amount by which image data can practically be reduced.

There is a need for addressing these issues and/or other issues associated with the prior art. For example, there is a need to provide improved lossy frame buffer compression.

### SUMMARY

A method, computer readable medium, and system are disclosed for providing lossy frame buffer compression. Lossy compression is performed on image data to generate a first compressed representation of the image data. Further, additional compression is performed on at least a portion of the first compressed representation of the image data to generate a second compressed representation of the image data. The second compressed representation of the image data is then stored to a memory.

### BRIEF DESCRIPTION OF THE DRAWINGS

FIG. 1 illustrates a method for compressing image data, in accordance with an embodiment.

FIG. 2 illustrates a system for frame buffer compression, in accordance with an embodiment.

FIG. 3 illustrates a visual representation of an image decomposed into image blocks, in accordance with an embodiment.

FIGS. 4A-C illustrate a visual representation of the compression of image data, in accordance with an embodiment.

FIG. 5 illustrates a method for compression of image data using color values, in accordance with an embodiment.

FIG. 6 illustrates a method for compression of image data using luminance and chrominance values, in accordance with an embodiment.

FIG. 7 illustrates an exemplary computing system, in accordance with an embodiment.

### DETAILED DESCRIPTION

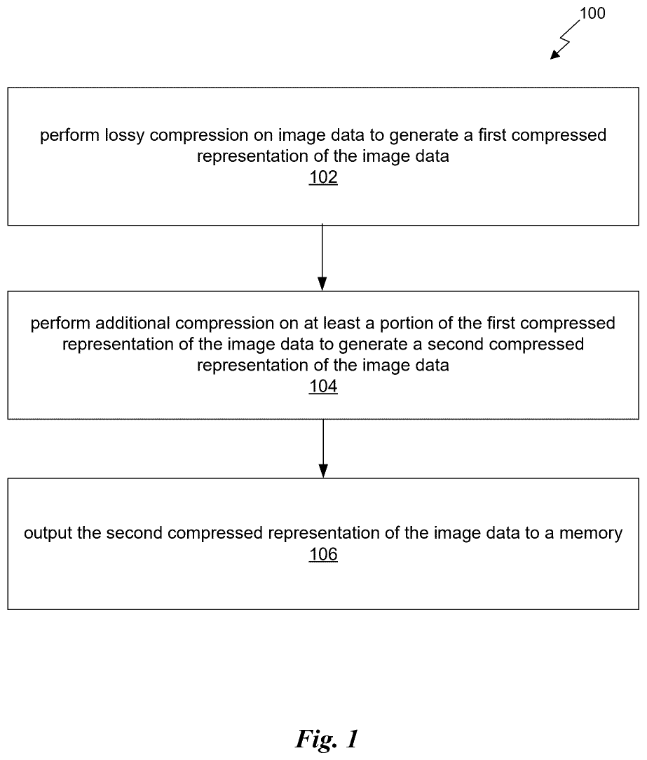

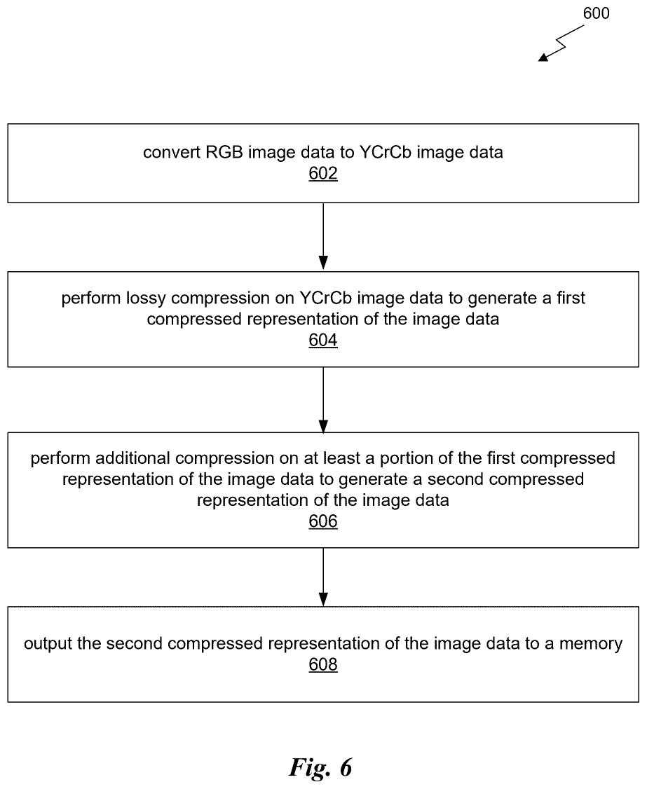

FIG. 1 illustrates a method 100 for compressing image data, in accordance with an embodiment. The method 100 may be performed by any device that includes a processing unit, a program, custom circuitry, and/or any combination of the same. For example, the method 100 may be executed by a GPU (graphics processing unit), CPU (central processing unit), or any processor capable of image processing. As another example, the method 100 may be performed by the computing system of FIG. 6. Furthermore, persons of ordinary skill in the art will understand that any system that performs the method 100 is within the scope and spirit of embodiments of the present disclosure.

In operation 102, lossy compression is performed on image data to generate a first compressed representation of the image data. The image data refers to data that represents (e.g. defines) at least a portion of an image. In an embodiment, the image data may be stored in a frame buffer. In an embodiment, the image data may be texture data.

In an embodiment, the image data may include pixel data. For example, each pixel of an image may be represented by data that defines a color of the pixel (e.g. RBG values). This pixel data may also define an opacity of the pixel (e.g. RGBA). In another example, the pixel data may define a luminance and chrominances of the pixel (e.g. YCrCb).

As mentioned, lossy compression is performed on the image data to generate a first compressed representation of the image data. The lossy compression refers to a compression scheme that provides for some loss of the original image data. In an embodiment, the lossy compression may be a fixed rate lossy compression (e.g. 50% compression). As a result, an entirety of the image data may be compressed down by the fixed rate to form the first compressed representation of the image data (e.g. that is 50% of the size of the non-compressed image data).

In an embodiment, the lossy compression may be a block compression scheme that compresses the image data on a block-by-block basis. For example, the image data may be decomposed into a plurality of blocks, with each block corresponding to a different portion of the image data such as a tile covering a section of the image data. Each block may have a defined height and width, and may cover a plurality of pixels each having corresponding pixel data.

In an embodiment, the lossy compression may be performed for each of a plurality of channels (e.g. color channels or a luminance/chrominances channels) of each of a plurality of blocks of the image data by identifying a plurality of data values in the block, determining a lower value (C₀) among the plurality of data values in the block, determining an upper value (C₁) among the plurality of data values in the block, and computing a plurality of index values for all the data values in the block. In an embodiment, the lossy compression may be performed for each of the plurality of channels of each of the plurality of blocks of the image data by storing C₀, storing C₁, and storing the plurality of index values.

In an embodiment, C₀ and C₁ may be stored in accordance with a defined order. In an embodiment, the index values may reference values linearly interpolated between C₀ and C₁ when C₀ is in the range [0.0, 1.0), C₁ is in the range [1.0, HALF_MAX], where HALF_MAX is a maximum value, and C₀<=C₁.

In an embodiment, 0.0 and 1.0 may be selectable for the index values and the index values may further reference values uniformly linearly interpolated between [C₀, C₁] when C₀ is in the range [0.0, 1.0], and C₁ is in the range [1.0, HALF_MAX], where HALF_MAX is a maximum value. In an embodiment, the index values may reference a logarithmic distribution of values when C₀ is in the range [1.0, HALF_MAX], and C₁ is in the range [1.0, HALF_MAX], where HALF_MAX is a maximum value.

In another embodiment, the index values may reference a first set of values linearly interpolated between [C₁, 1.0] and a second set of values linearly interpolated between [1.0, C₀] when C₀ is in the range [0.0, 1.0), C₁ is in the range [1.0, HALF_MAX], where HALF_MAX is a maximum value, and C₀>C₁. As an example to this embodiment, a number of values included in the first set of values and a number of values included in the second set of values may be equal. As another example to this embodiment, a number of values included in the first set of values may be determined as a function of a difference between 1.0 and C₁, and a remaining number of values may be used for the second set of values. As yet another example to this embodiment, a number of values included in the first set of values may be determined as a function of a difference between 1.0 and C₁ and a difference between C₀ and 1.0, and a remaining number of values may be used for the second set of values.

In an embodiment, for each of a plurality of channels of each of a plurality of blocks of the image data, at least one least significant bit (LSB) of C₀ (e₀) and at least one LSB of C₁ may be reserved for another use by the algorithm used for the lossy compression. For example, with respect to this embodiment, for each of the plurality of channels of each of the plurality of blocks of the image data: e₀=1 when C₁−C₀<threshold (t), otherwise e₀=0, and when e₀==1, then C₁ is not stored and index values are not stored, else when e₀==0, then a number of index values are computed as a function of a difference between C₁ and C₀. Further to this embodiment, different compression rates may be possible for the different channels of the image data. As a further embodiment, each of a plurality of blocks of the image data may be downsampled (e.g. in one dimension, in two dimensions, etc.) for one or more channels of data prior to computing the index values, and the reserved bits may be used to indicate the downsampling.

In an embodiment, dithering may be used in the computation of the index values. In an embodiment, a pseudorandom number may be used for the dithering. In an embodiment, spatiotemporal blue noise is used for the dithering.

In any case, the lossy compression performed in operation 102 generates the first compressed representation of the image data. In operation 104, additional compression is performed on at least a portion of the first compressed representation of the image data to generate a second compressed representation of the image data. The additional compression refers to at least on additional compression operation that is performed on at least a portion of the first compressed representation of the image data. In embodiments, the lossy compression and the additional compression may be performed in separate steps or may be performed in a combined single step.

In an embodiment, the additional compression may be a lossless compression. Lossless compression refers to a compression scheme in which data is only compressed when the compression will result in less than a threshold loss of information. In another embodiment, the additional compression may be another lossy compression operation (subsequent to the lossy compression performed in operation 102).

In an embodiment, the additional compression may be a single compression operation that compresses the at least a portion of the first compressed representation of the image data directly to the second compressed representation of the image data. In another embodiment, the additional compression may include two or more sequential compression operations, where each intermediate compression operation generates a sequentially more compressed representation of the image data to form an intermediate compressed representation of the image data and where a last compression operation compresses the intermediate compressed representation of the image data to the second compressed representation of the image data.

In an embodiment, the method 100 may include selecting the at least one portion of the first compressed representation of the image data on which to perform the additional compression. In an embodiment, each portion in the at least one portion may be selected based on a determination that a loss resulting from applying the additional compression to the portion is less than a predefined amount. In embodiments, the additional compression may compress the at least a portion of the first compressed representation to 25%, 12.5%, etc.

In operation 106, the second compressed representation of the image data is stored to a memory. The memory may be a local memory or a remote memory. In an embodiment, the memory may be a temporary storage location from which the second compressed representation of the image data is transmitted (e.g. over a network) to a remote system, which may in turn decompress the second compressed representation of the image data to generate decompressed image data, render the decompressed image data and display the decompressed image data. In an embodiment, the memory may be a storage from which the second compressed representation of the image data may be locally decompressed, rendered and displayed.

To this end, the method 100 is performed to compress the image data using both a lossy compression operation and at least one additional compression operation. It should be noted that while the method 100 refers to performing the lossy compression and the additional compression in sequence, other embodiments are contemplated in which a first compression (lossy or lossless) of the image data may be performed to generate the first compressed representation of the image data and subsequently an additional lossy compression may be performed on the first compressed representation of the image data to generate the second compressed representation of the image data. In another possible embodiment, one or more earlier compression operations may be applied to uncompressed image data prior to performing the lossy and additional compression operations.

In one embodiment, image data may be compressed over at least two compression operations to form compressed image data, where at least one compression operation of the at least two compression operations is a lossy compression. The compressed image data may then be output to a memory. In an embodiment, a first compression operation of the at least two compression operations includes the lossy compression. In an embodiment, a second compression operation of the at least two compression operations includes a lossless compression.

Additionally, in an embodiment, each compression operation of the method 100 may be performed on each of a plurality of portions (e.g. blocks) of the image data. In an embodiment, each compression operation may involve compressing two or more portions of the image data in parallel. In an embodiment, each compression operation may involve compressing two or more portions of the image data in sequence. In an embodiment, the lossy compression operation and the additional compression operation may at least in part overlap (in time). For example, one or more lossy compressed portions of the image data may be processed by the additional compression scheme while one or more other portions of the image data are still being compressed by the lossy compression scheme.

By employing the lossy compression of the image data, the method 100 reduces both bandwidth required to transmit the image data as well as memory required to store the image data. Moreover, by employing the additional compression, which may be lossless, the method 100 even further reduces the bandwidth required to transmit the image data.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

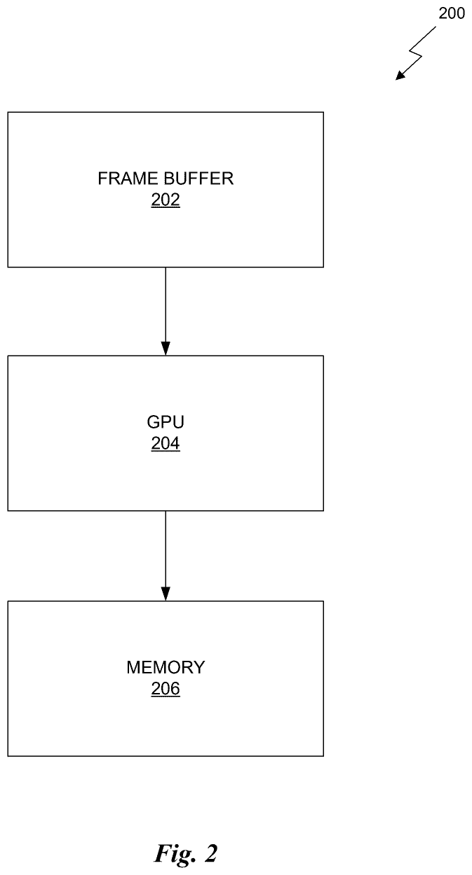

FIG. 2 illustrates a system 200 for frame buffer compression, in accordance with an embodiment. In an embodiment, the system 200 may be implemented in the context of the method 100 of FIG. 1. For example, the GPU 204 of the system 200 may perform the method 100 of FIG. 1. In any case, it should be noted that the descriptions and definitions provided above may equally apply to the present embodiment.

The system 200 includes a frame buffer 202 that stores image data. The image data may be an image or a portion of an image. The image data may be a frame of video. The frame buffer 202 may operate to temporarily store image data for compression thereof.

A GPU 204 of the system 200 accesses the frame buffer 202 to retrieve the image data stored therein. The GPU 204 compresses the image data over multiple compression operations, at least one of which is a lossy compression operation. In an embodiment, the GPU 204 performs lossy compression on the image to data to generate a first compressed representation of the image data, and subsequently performs additional compression on at least a portion of the first compressed representation of the image data to generate a second compressed representation of the image data.

The GPU 204 outputs the second compressed representation of the image data to a memory 206 of the system 200. In an embodiment, the second compressed representation of the image data may be transmitted from the memory 206 to a remote destination device for decompression, rendering and display thereof. In another embodiment, the second compressed representation of the image data may be decompressed, rendered and displayed directly from the memory 206.

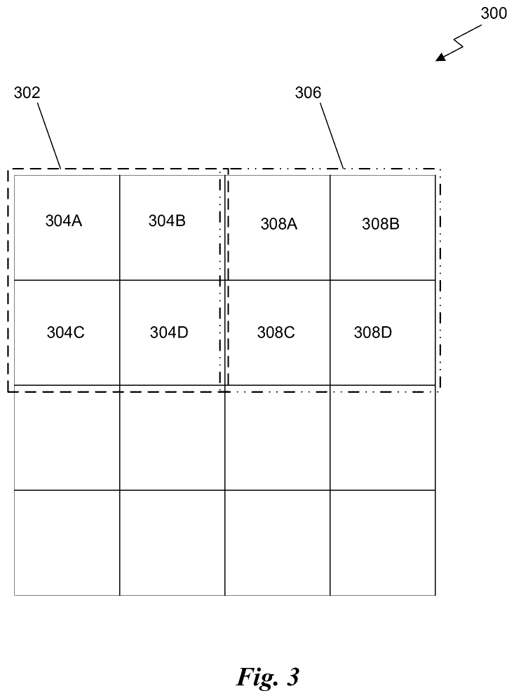

FIG. 3 illustrates a visual representation of an image 300 decomposed into image blocks, in accordance with an embodiment. The image 300 may be stored in the frame buffer 202 of FIG. 2.

The image 300 includes rows and columns of image elements (e.g. pixels). The image 300 is decomposed into image blocks that each include a different subset of the image elements. For example, image block 302 includes image elements 304A-D. Likewise, image block 306 includes image elements 308A-D. It should be noted that most block compression schemes use 4×4 pixels per block instead of 2×2 as shown here. The 2×2 example shown is only for illustration.

When a block of an image is compressed, the image elements therein are encoded in accordance with the compression scheme used. The compressed representation of the block will accordingly utilize less bits to represent the original (uncompressed) block of the image. In an embodiment, a compressed representation resulting from compression of a block 302 may store two representative values (as bit sets) selected, or otherwise derived, from image elements 304A-D, and all in a block image elements 304A-D may each point to one of the two representative values or to a value interpolated therebetween.

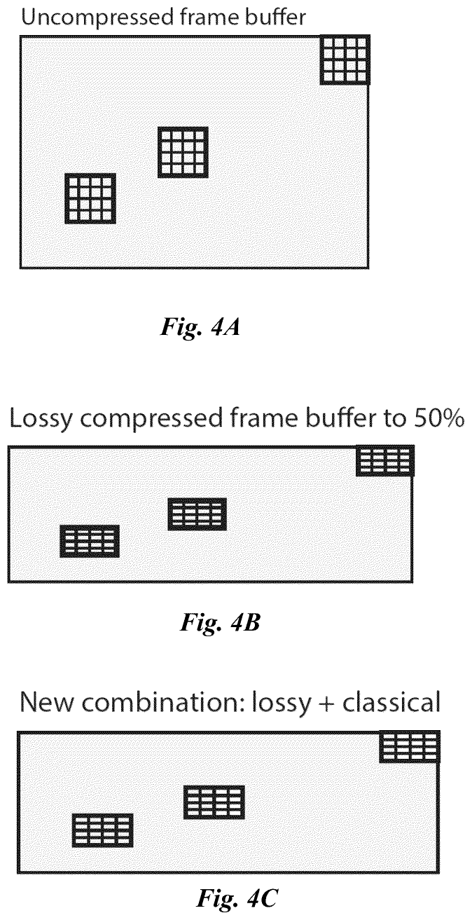

FIGS. 4A-C illustrate a visual representation of the compression of image data, in accordance with an embodiment. In each of FIGS. 4A-C, an outer dimension of the image data represents an amount of memory the image data occupies. Thus, the non-compressed image data in FIG. 4A occupies a greater amount of memory than the compressed image data in FIGS. 4B and 4C.

As shown in FIG. 4A, the image data is composed of many small (non-overlapping) blocks. While not shown, it should be noted that the blocks may be contiguous, in an embodiment. Further, while the example illustrates each block as including 4×4 pixels, other block sizes may be employed.

FIG. 4B illustrates a first compressed representation of the image data generated from performing lossy compression on the image data in FIG. 4A. In the present example, the image data is lossy compressed to 50%, but other compression rates may also be employed. This compression is visualized as smaller block sizes than the block sizes included in the non-compressed image data of FIG. 4A. The reduced block size requires (e.g. 50%) less memory for storage thereof and also guarantees that bandwidth for transmission is reduced (e.g. by 50%).

FIG. 4C illustrates a second compressed representation of the image data generated from performing lossless compression on at least a portion of the first compressed representation of the image data in FIG. 4B. The white sub-blocks indicate that the memory is not used, or in other words that the data in such sub-blocks has been compressed. In the example shown, the middle block is further compressed by 50% down to 25% and the right block is further compressed by 25% down to 12.5%. However, the left block is not further compressed at all, which may be a result of a determination that compressing the left block would result in more than an acceptable level of information loss. Note that the second compressed representation of the image data uses the same amount of memory as the first compressed representation of the image data, so the second compressed representation of the image data does not save on memory but it does save on bandwidth when transmitted over a memory bus because the white sub-blocks of a compressed block do not need to be sent over the bus.

Thus, using the lossy compression operation on the image data guarantees that at least the lossy compression rate (in this case 50%) is realized and thus at least a memory and bandwidth reduction (e.g. of 50%) is obtained. Then on top of this memory/bandwidth savings, further bandwidth savings are obtained as a result of the lossless compression operation which compresses at least some of the blocks by a further amount (e.g. to 25%, 12.5%, etc.). Of course, it should be noted that in another embodiment the additional compression operation may be a lossy compression operation instead of the lossless compression operation.

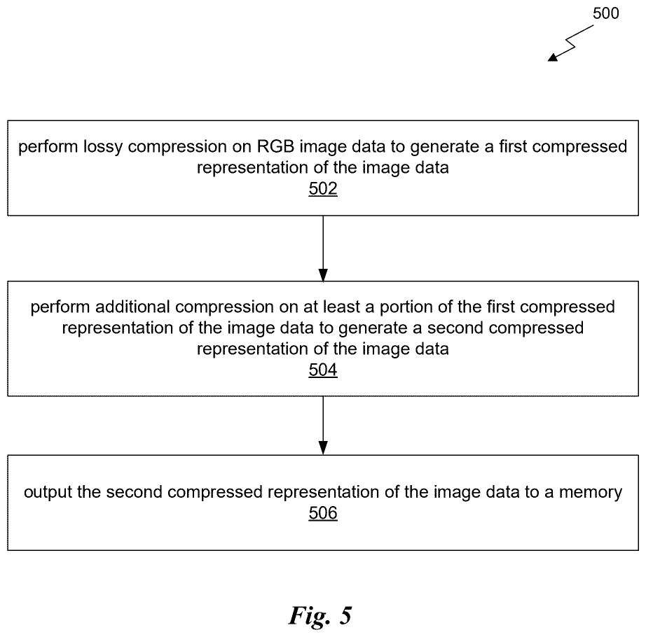

FIG. 5 illustrates a method 500 for compression of image data using color values, in accordance with an embodiment. The method 500 may be carried out on the context of any of the embodiments of the previous figures. For example, the method 500 may be carried out via the system 200 of FIG. 2. The descriptions and definitions provided above may equally apply to the present embodiment.

In operation 502, lossy compression is performed on RGB image data to generate a first compressed representation of the image data. The RGB image data may include RGBA image data, in an embodiment.

In an embodiment, the lossy compression may be performed for one or more channels of the image data. In a standard BC4 algorithm, for a given channel, the lossy compression will reduce a block of the image data to a lower value, c₀, an upper value, c₁, and a number of index bits per pixel (3 index bits in a 4×4 block). The 3-bit index per pixel is referred to as vᵢⱼ, where ij are coordinates inside the block. For BC4, a texel is decoded per Equation 1.

$${c}_{ij} = \frac{( 7 - {v}_{ij} ) {c}_{0} + {v}_{ij} {c}_{1}}{7} \qquad Equation 1$$

This creates a linear interpolation of 8 colors from c₀ to c₁. This can be generalized so that an N-bit value, vᵢⱼ, is used per texel instead. A texel is then decoded as per Equation 2.

$${c}_{ij} = \frac{( {2}^{N} - 1 - {v}_{ij} ) {c}_{0} + {v}_{ij} {c}_{1}}{{2}^{N} - 1} \qquad Equation 2$$

Note that the index bit values, vᵢⱼ, have integer values in [0,2^{N}−1], or in other words for BC4 with N=3, the range is [0,7].

In the following described embodiment, the lossy compression corresponds to RGBA16Float buffers, but it should be noted that this compression can be generalized to any type of buffer. For a single channel of such an RGBA16Float buffer, in an uncompressed mode a 4×4 block of RGBA16Float pixels consume 2 bytes per channel times 4 channel times 4×4 pixels, i.e., 2*4*4*4=128 bytes.

To compress the image data, the lower value, c₀, and the upper value, c₁, of the block may be stored in a half float, i.e., using 16 bits. In addition, each pixel may store 6 index bits. This means that each channel stores 6*4*4 index bits and 16+16 bits for the lower and upper values per block. In total this is 128 bits=16 bytes per channel per block, i.e., 16*4=64 bytes for all 4 channels (RGBA) for a 4×4 block. This means that a 50% guaranteed compression rate is achieved.

In operation 504, additional compression is performed on at least a portion of the first compressed representation of the image data to generate a second compressed representation of the image data. The additional compression may be lossless compression, such as a standard block compression method. In operation 506, the second compressed representation of the image data is then stored to a memory.

FIG. 6 illustrates a method 600 for compression of image data using luminance and chrominance values, in accordance with an embodiment. The method 600 may be carried out on the context of any of the embodiments of the previous figures. For example, the method 600 may be carried out via the system 200 of FIG. 2. The descriptions and definitions provided above may equally apply to the present embodiment.

In operation 602, RGB image data is converted to YCrCb image data. For example, for the RGB values for each pixel may be converted to YCrCb values, where Y is the luminance and Cr and Cb are two chrominance channels. The conversion of the RGB (color) image data to the YCrCb (luminance/chrominance) image data may be performed using a preconfigured algorithm. In particular, the algorithm may be a transform that decorrelates the RGB image data to form the YCrCb image data.

In an embodiment where the RGB image data includes RGBA image data, the alpha component, A, may be left unchanged when converting to the YCrCb image data, such that the YCrCb image data may include the alpha component. Instead of allocating 6 index bits for each of RGB, 8 index bits may be allocated for each Y and 5 index bits for each Cr and Cb, such that the sum is 8+5+5 index bits for YCrCb, compared to 6+6+6 index for RGB thereby maintaining a same cost.

In operation 604, lossy compression is performed on the YCrCb image data to generate a first compressed representation of the image data. In an embodiment, the lossy compression may include the same compression method described above with respect to FIG. 5, operating on one or more channels of the YCrCb image data.

In another embodiment, a modification to the compression method described above with respect to FIG. 5 may be employed which extracts one more bit that can be used for some purpose selected by the compression algorithm. In this embodiment, an order may be imposed on c₀ and c₁. In particular, it can be assumed that c₀<C₁, but configuring the compression algorithm to swap these values so that c₀>=c₁ will allow this swap to be used as the extra bit. For example, if c₀<C₁ then the bit=0, otherwise the bit=1. This modified compression method may be used for blocks that contain some skewed distributions of values between the minimum and maximum values of c₀ and c₁. Assuming that c₀<=C₀ to start with, the problematic case occurs when c₀ is in [0.0, 1.0) and c₀ is in [1.0, HALF_MAX]. Note that [0.0, 1.0) includes 0.0 and all numbers up to 1.0, but not including exactly 1.0. This case can be handled as set forth in Table 1.

```
TABLE 1
1. If c₀ is in [0.0, 1.0) and c₁ is in [1.0, HALF_MAX]:
  a. If c₀ <= c₁ use standard linear interpolation as described above, i.e., using the
  2^{N} values per index.
  b. Else use standard interpolation using for 2^{N}−1 values between [c₁, 1.0] and the
  other 2^{N}−1 values for [1.0, c₀]. Recall that now c₀ > c₁, and so c₁ <= 1.0, and c₀
  >=1.0.
```

For 1b above, more elaborate scheme may also be used to distribute the N bits for the ranges [c₁, 1.0] and [1.0, c₀]. Parts of the 2^{N} values can be used for a first group [c₁, 1.0] and the remaining values used for a second group [1.0, c₀]. The “sizes” of the two groups may determine the distribution. The size of the first group may be referred to as s₀=1.0−c₁, and the size of the second group may be referred to as s₁=c₀−1.0.

For example, so may be used to control the distribution of values. If s₀>0.5 then 2^{N}−1 values may be used for the first group, but when 0.5>=s₀>0.25, then 2^{N}−2 values may be used, and for 0.25>=s₀>0.125, then 2^{N}−3 values may be used, and so on, down to 4, 2, and 1 value. The remaining values would be used for the second group. This method only uses so to determine the number of values for the first group.

There are cases other than that shown in Tabel 1 that may arise, per Table 2.

TABLE 2

2. c₀ is in [0.0, 1.0] and c₁ is in [0.0, 1.0], or
3. c₀ is in [1.0, HALF_MAX] and c₁ is in [1.0, HALF_MAX]

For these other cases 2 and 3 the extracted bit can be used in different ways. For case 2, 0.0 and 1.0 can always be made selectable, and then uniform linear interpolation between c₀ and c₁ may be used for the rest of the values. For case 3, a specialized distribution of the values may be used, such as a logarithmic distribution (which will result in more values closer to 1.0 increasingly fewer the higher up). This can efficiently be accomplished by interpolating in the integer domain (i.e., converting from half float to 16-bit integers first, and then doing the interpolation).

In another possible embodiment, both s₀ and s₁ can be used to determine the number of values for the first group with remaining values in the second group).

In operation 606, additional compression is performed on at least a portion of the first compressed representation of the image data to generate a second compressed representation of the image data. The additional compression may be lossless compression, such as a standard block compression method.

In an embodiment, to reach good compression rates, c₀ and c₁ may be stored using 15-bit half floats instead of 16-bit half floats, such that the two least significant bits (LSBs) can be used for other purposes. For each channel, the additional compression method may follow the steps of Table 3.

TABLE 3

| 1. | c₀: store using 15-bit half float (not using 1 LSB mantissa bit). The unused LSB bit is | |
|---|---|---|
| | referred to as e₀. | |
| 2. | Set e₀=1 if c₁ − c₀ < a very small predefined number, which means that c₀ and c₁ are | |
| | approximately the same, and otherwise, e₀=0. | |
| | a. | If e₀==1, then do not store c₁ and do not store any index bits for this channel, |
| | | which saves space. |
| | b. | Else if e₀==0, then compute the number of index bits based on c₁ − c₀ as shown |
| | | below: |
| | | half minError = 0.005h; // Can be set to a higher value for more |
| | | compression. |
| | | half diff = c₁ − c₀; if (diff < minError) return 0; |
| | | return int(log2(diff / minError)) + 1; // num bits for channel |

When the number of bits has been computed for the entire block, the bits are clamped to the 50% budget, which is the maximum rate desired (but preferably, a rate than 50% will be achieved). To this end, each channel of the image data may be compressed down to different rates.

This compression method may also be combined with more aggressive methods. For example, if the chrominance content, Cr and Cb, of a block varies little, one can consider to subsample the chrominances, which means that fewer index bits would be needed. For example, instead of 5 index bits per pixel per 4×4 block, i.e., 4×4×5=80 bits, this could be downsampled to 2×2 values, i.e., 2×2×5=20 bits. This can be done independently for Cr and Cb per block.

However, this downsampling needs to be indicated somewhere, and so as an option yet another LSB may be taken from c₀ and c₁ for this purpose. To generalize, downsampling only in one dimension may be performed, i.e., instead of downsampling for each 2×2 pixels, downsampling can be performed for 2×1 or 1×2 pixels, which will result in better quality (but at higher index bit cost).

In general, for blocks with smoothly varying content, e.g., a gradient, banding artifacts can sometimes be visible. In an embodiment, dithering may be used to make this less visible. In this embodiment, dithering can be inserted by the compressor when the indices are computed, using the index computation in Equation 3.

$$Index [ i ] [ j ] = in ( ( value [ i ] [ j ] + ditehrOffset [ i ] [ j ] + delta * 0.5 - {c}_{0} ) / delta ) \qquad Equation 3$$

where value [i][j] is the channel value at pixel i,j inside a block and delta is

$$\frac{{c}_{1} - {c}_{0}}{{2}^{N} - 1} ,$$

and
where ditherOffset[i][j] is some pseudorandom number in [−0.5, +0.5] times delta.

It should be noted that other factor than 0.5 can be used to get more or less dithering impact. In another embodiment, spatiotemporal blue noise may be used.

In operation 608, the second compressed representation of the image data is then stored to a memory.

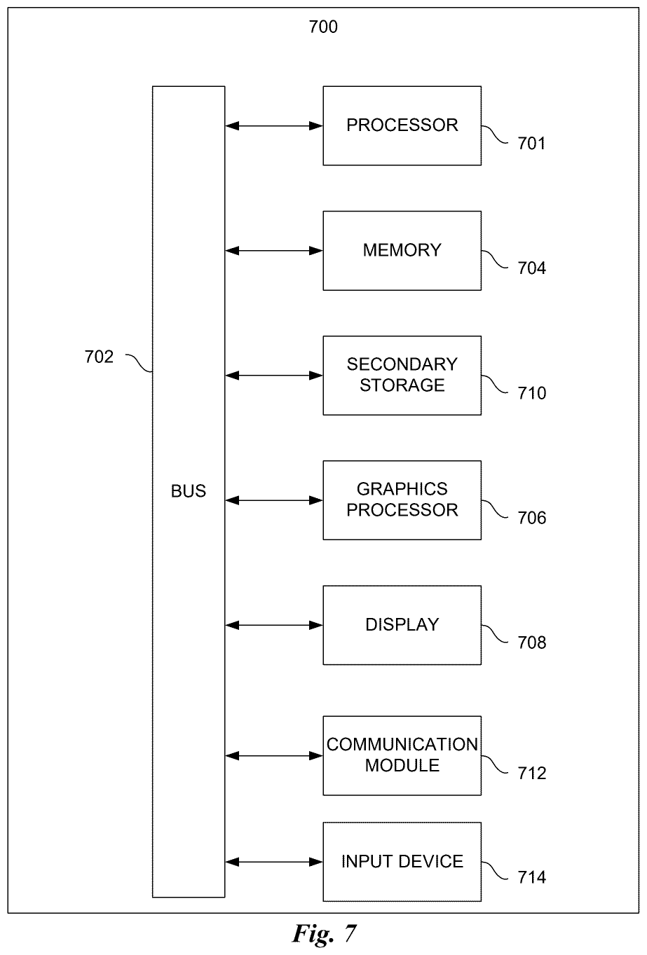

FIG. 7 illustrates an exemplary computing system 700, in accordance with an embodiment. One or more of the components shown in system 700 may be implemented within the messaging devices and switches described herein, such that the hardware and software of the messaging devices and switches are configured to enable the messaging devices and switches to function in accordance with the embodiments described.

As shown, the system 700 includes at least one central processor 701 which is connected to a communication bus 702. The system 700 also includes main memory 704 [e.g. random access memory (RAM), etc.]. The system 700 also includes a graphics processor 706 and a display 708.

The system 700 may also include a secondary storage 710. The secondary storage 710 includes, for example, a hard disk drive and/or a removable storage drive, representing a floppy disk drive, a magnetic tape drive, a compact disk drive, a flash drive or other flash storage, etc. The removable storage drive reads from and/or writes to a removable storage unit in a well-known manner.

Computer programs, or computer control logic algorithms, may be stored in the main memory 704, the secondary storage 710, and/or any other memory, for that matter. Such computer programs, when executed, enable the system 700 to perform various functions, including for example sending, receiving, and/or processing messages in accordance with the epoch-based messaging protocol. Memory 704, storage 710 and/or any other storage are possible examples of non-transitory computer-readable media.

The system 700 may also include one or more communication modules 712. The communication module 712 may be operable to facilitate communication between the system 700 and one or more networks, and/or with one or more devices (e.g. game consoles, personal computers, servers etc.) through a variety of possible standard or proprietary wired or wireless communication protocols (e.g. via Bluetooth, Near Field Communication (NFC), Cellular communication, etc.).

As also shown, the system 700 may include one or more input devices 714. The input devices 714 may be a wired or wireless input device. In various embodiments, each input device 714 may include a keyboard, touch pad, touch screen, game controller, remote controller, or any other device capable of being used by a user to provide input to the system 700.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method comprising:
at a device:
performing lossy compression on image data to generate a first compressed representation of the image data;
performing additional compression on at least a portion of the first compressed representation of the image data to generate a second compressed representation of the image data; and
outputting the second compressed representation of the image data to a memory.

2. The method of claim 1, wherein the lossy compression is a fixed rate lossy compression.

3. The method of claim 1, wherein the additional compression is one of:
lossless compression, or
lossy compression.

4. The method of claim 1, further comprising, at the device:
selecting the at least one portion of the first compressed representation of the image data on which to perform the additional compression.

5. The method of claim 4, wherein each portion in the at least one portion is selected based on a determination that a loss resulting from applying the additional compression to the portion is less than a predefined amount.

6. The method of claim 1, wherein the lossy compression is performed for each of a plurality of channels of each of a plurality of blocks of the image data by:
identifying a plurality of data values in the block,
determining a lower value (C₀) among the plurality of data values in the block,
determining an upper value (C₁) among the plurality of data values in the block, and computing a plurality of index values for all data values in the block.

7. The method of claim 6, wherein the plurality of channels include color channels.

8. The method of claim 6, wherein the plurality of channels include a luminance channel and two chrominance channels.

9. The method of claim 6, wherein dithering is used in the computation of the index values.

10. The method of claim 9, wherein a pseudorandom number is used for the dithering.

11. The method of claim 9, wherein spatiotemporal blue noise is used for the dithering.

12. The method of claim 6, wherein the lossy compression is performed for each of the plurality of channels of each of the plurality of blocks of the image data by:
storing C₀,
storing C₁, and
storing the plurality of index values.

13. The method of claim 6, wherein C₀ and C₁ are stored in accordance with a defined order.

14. The method of claim 6, wherein the index values reference values linearly interpolated between C₀ and C₁ when:
C₀ is in the range [0.0, 1.0),
C₁ is in the range [1.0, HALF_MAX], where HALF_MAX is a maximum value, and
C₀<=C₁.

15. The method of claim 6, wherein the index values reference a first set of values linearly interpolated between [C₁, 1.0] and a second set of values linearly interpolated between [1.0, C₀] when:
C₀ is in the range [0.0, 1.0),
C₁ is in the range [1.0, HALF_MAX], where HALF_MAX is a maximum value, and
C₀>C₁.

16. The method of claim 15, wherein a number of values included in the first set of values and a number of values included in the second set of values are equal.

17. The method of claim 15, wherein a number of values included in the first set of values is determined as a function of a difference between 1.0 and C₁, and wherein a remaining number of values are used for the second set of values.

18. The method of claim 15, wherein a number of values included in the first set of values is determined as a function of a difference between 1.0 and C₁ and a difference between C₀ and 1.0, and wherein a remaining number of values are used for the second set of values.

19. The method of claim 6, wherein 0.0 and 1.0 are selectable for the index values and wherein the index values further reference values uniformly linearly interpolated between [C₀, C₁] when:
C₀ is in the range [0.0, 1.0], and
C₁ is in the range [1.0, HALF_MAX], where HALF_MAX is a maximum value.

20. The method of claim 6, wherein the index values reference a logarithmic distribution of values when:
C₀ is in the range [1.0, HALF_MAX], and
C₁ is in the range [1.0, HALF_MAX],
where HALF_MAX is a maximum value.

21. The method of claim 6, wherein for each of a plurality of channels of each of a plurality of blocks of the image data, at least one least significant bit (LSB) of C₀ (e₀) and at least one LSB of C₁ are reserved for another use by the algorithm used for the lossy compression.

22. The method of claim 21, wherein for each of the plurality of channels of each of the plurality of blocks of the image data:
e₀=1 when C₁−C₀<threshold (t), otherwise e₀=0, and
when e₀==1, then C₁ is not stored and index values are not stored, else
when e₀==0, then a number of index values are computed as a function of a difference between C₁ and C₀.

23. The method of claim 22, wherein different compression rates are possible for the different channels of the image data.

24. The method of claim 21, wherein each of a plurality of blocks of the image data is downsampled for one or more channels of data prior to computing the index values, and wherein the reserved bits are used to indicate the downsampling.

25. The method of claim 24, wherein each of the plurality of blocks are downsampled in two dimensions.

26. The method of claim 24, wherein each of the plurality of blocks are downsampled in one dimension.

27. The method of claim 1, wherein the image data is stored in a frame buffer.

28. The method of claim 1, wherein the image data is texture data.

29. The method of claim 1, wherein the lossy compression and the additional compression are performed by a graphics processing unit (GPU).

30. The method of claim 1, wherein the lossy compression compresses the image data to 50%.

31. The method of claim 1, wherein the additional compression compresses the at least a portion of the first compressed representation to 25%.

32. The method of claim 1, wherein the additional compression compresses the at least a portion of the first compressed representation to 12.5%.

33. The method of claim 1, wherein the additional compression is a single compression operation that compresses the at least a portion of the first compressed representation of the image data directly to the second compressed representation of the image data.

34. The method of claim 1, wherein the additional compression includes two or more sequential compression operations, wherein a last compression operation of the two or more sequential compression operations compresses an intermediate compressed representation of the image data generated by a prior compression operation of the two or more sequential compression operations to the second compressed representation of the image data.

35. A system, comprising:
a non-transitory memory storage of a device comprising instructions; and
one or more processors of the device in communication with the non-transitory memory storage, wherein the one or more processors execute the instructions to:
perform lossy compression on image data to generate a first compressed representation of the image data;
perform additional compression on at least a portion of the first compressed representation of the image data to generate a second compressed representation of the image data; and
output the second compressed representation of the image data to a memory.

36. The system of claim 35, wherein the image data is stored in a frame buffer.

37. The system of claim 35, wherein the image data is texture data.

38. The system of claim 35, wherein the lossy compression is a fixed rate lossy compression.

39. The system of claim 35, wherein the additional compression is one of:
lossless compression, or
lossy compression.

40. The system of claim 35, further comprising, at the device:
selecting the at least one portion of the first compressed representation of the image data on which to perform the additional compression.

41. The system of claim 40, wherein each portion in the at least one portion is selected based on a determination that a loss resulting from applying the additional compression to the portion is less than a predefined amount.

42. The system of claim 35, wherein the one or more processors are a graphics processing unit (GPU).

43. The system of claim 35, wherein the additional compression is a single compression operation that compresses the at least a portion of the first compressed representation of the image data directly to the second compressed representation of the image data.

44. The system of claim 35, wherein the additional compression includes two or more sequential compression operations, wherein a last compression operation of the two or more sequential compression operations compresses an intermediate compressed representation of the image data generated by a prior compression operation of the two or more sequential compression operations to the second compressed representation of the image data.

45. A non-transitory computer-readable media storing computer instructions which when executed by one or more processors of a device cause the receiving device to:
perform lossy compression on image data to generate a first compressed representation of the image data;
perform additional compression on at least a portion of the first compressed representation of the image data to generate a second compressed representation of the image data; and
output the second compressed representation of the image data to a memory.

46. The non-transitory computer-readable of claim 45, wherein the image data is stored in a frame buffer.

47. The non-transitory computer-readable of claim 45, wherein the image data is texture data.

48. The non-transitory computer-readable of claim 45, wherein the lossy compression is a fixed rate lossy compression.

49. The non-transitory computer-readable of claim 45, wherein the additional compression is one of:
lossless compression, or
lossy compression.

50. The non-transitory computer-readable of claim 45, further comprising, at the device:
selecting the at least one portion of the first compressed representation of the image data on which to perform the additional compression.

51. The non-transitory computer-readable of claim 50, wherein each portion in the at least one portion is selected based on a determination that a loss resulting from applying the additional compression to the portion is less than a predefined amount.

52. The non-transitory computer-readable of claim 45, wherein the one or more processors are a graphics processing unit (GPU).

53. The non-transitory computer-readable of claim 45, wherein the additional compression is a single compression operation that compresses the at least a portion of the first compressed representation of the image data directly to the second compressed representation of the image data.

54. The non-transitory computer-readable of claim 45, wherein the additional compression includes two or more sequential compression operations, wherein a last compression operation of the two or more sequential compression operations compresses an intermediate compressed representation of the image data generated by a prior compression operation of the two or more sequential compression operations to the second compressed representation of the image data.

55. A method comprising:
at a device:
compressing image data over at least two compression operations to form compressed image data, wherein at least one compression operation of the at least two compression operations is a lossy compression; and
outputting the compressed image data to a memory.

56. The method of claim 55, wherein a first compression operation of the at least two compression operations includes the lossy compression.

57. The method of claim 56, wherein a second compression operation of the at least two compression operations includes a lossless compression.

58. The method of claim 56, wherein a second compression operation of the at least two compression operations includes a lossy compression.
